(19) United States
(12) Patent Application Publication
(10) Pub. No.: US 2020/0089645 A1
(43) Pub. Date: Mar. 19, 2020

(54) SECURITY TECHNIQUES FOR A PERIPHERAL COMPONENT INTERCONNECT (PCI) EXPRESS (PCIE) SYSTEM

(71) Applicant: QUALCOMM Incorporated, San Diego, CA (US)

(72) Inventors: Yiftach Benjamini, Givat Ela (IL); Lior Amarilio, Yokneam (IL); Amit Gil, Zichron Yaakov (IL); James Lionel Panian, San Marcos, CA (US); Dafna Shaool, Binyamina (IL)

(21) Appl. No.: 16/569,816

(22) Filed: Sep. 13, 2019

Related U.S. Application Data
(60) Provisional application No. 62/731,286, filed on Sep. 14, 2018.
(60) Provisional application No. 62/745,542, filed on Oct. 15, 2018.
(60) Provisional application No. 62/788,264, filed on Jan. 4, 2019.
(60) Provisional application No. 62/840,643, filed on Apr. 30, 2019.

(51) Int. Cl. G06F 13/42; H04L 9/08

(52) U.S. Cl. CPC G06F 13/4282; G06F 2213/0026; H04L 9/0861

(57) ABSTRACT

Security techniques for a Peripheral Component Interconnect (PCI) express (PCIE) system include a transport layer protocol (TLP) packet that has a prepended TLP prefix indicating the security features of the TLP packet and an integrity check value (ICV) appended to the TLP packet. The ICV is based on the TLP packet and any TLP prefixes including a security prefix. At a receiver, if the ICV does not match, then the receiver has evidence that the TLP packet may have been subjected to tampering. Further, the TLP packet may be encrypted to prevent snooping, and this feature would be indicated in the TLP prefix. Still further, the TLP prefix may include a counter that may be used to prevent replay attacks. PCIE contemplates flexible TLP prefixes, and thus, the standard readily accommodates the addition of a TLP prefix which indicates the security features of the TLP packet.

### PRIORITY APPLICATIONS

The present application is related to and claims the benefit of U.S. Provisional Patent Application Ser. No. 62/731,286, filed Sep. 14, 2018 and entitled “SECURITY TECHNIQUES FOR A PERIPHERAL COMPONENT INTERCONNECT (PCI) EXPRESS (PCIE) SYSTEM.”

The present application is also related to and claims the benefit of U.S. Provisional Patent Application Ser. No. 62/745,542, filed Oct. 15, 2018 and entitled “SECURITY TECHNIQUES FOR A PERIPHERAL COMPONENT INTERCONNECT (PCI) EXPRESS (PCIE) SYSTEM.”

The present application is also related to and claims the benefit of U.S. Provisional Patent Application Ser. No. 62/788,264, filed Jan. 4, 2019 and entitled “SECURITY TECHNIQUES FOR A PERIPHERAL COMPONENT INTERCONNECT (PCI) EXPRESS (PCIE) SYSTEM.”

The present application is related to and claims the benefit of U.S. Provisional Patent Application Ser. No. 62/840,643, filed Apr. 30, 2019 and entitled “SECURITY TECHNIQUES FOR A PERIPHERAL COMPONENT INTERCONNECT (PCI) EXPRESS (PCIE) SYSTEM.”

The above-listed applications are incorporated by reference in their entireties.

### BACKGROUND

### I. Field of the Disclosure

The technology of the disclosure relates generally to Peripheral Component Interconnect (PCI) express (PCIE) systems and, more particularly, to providing security to such PCIE systems.

### II. Background

Computing devices have become common in modern society. The increase in use of computing devices is attributable, in part, to increased functionality of the devices. In many instances, the increase in functionality is a result of different integrated circuits (ICs) within the computing device, each having different capabilities. A byproduct of having plural ICs in a computing device is a requirement to have some mechanism through which the ICs may communicate.

One popular mechanism is a bus compliant with the Peripheral Component Interconnect (PCI) standard. PCI has evolved through several versions and has a variety of variations. Perhaps the most popular variation as of this writing is PCI Express (PCIE). At the time of the parent provisional applications, the most recent version of PCIE was revision 5.0, version 0.7, which was published on Mar. 31, 2018. More recently revision 5.0, version 1.0 was published on May 28, 2019. While the PCIE standard is flexible and widely used, it has, to date, not incorporated any security measures to prevent unauthorized tampering, snooping, replays, or the like.

Historically, the lack of security measures was mitigated by the fact that the conductors that carried PCIE-compliant signals were relatively inaccessible within a computing device. However, recent developments have seen PCIE adopted outside traditional computing devices and expanded into roles previously not contemplated. For example, PCIE may be used within a wiring harness within a vehicle. The longer conductors between components leads to greater vulnerability and increases the need for a security system for a PCIE link.

### SUMMARY OF THE DISCLOSURE

Aspects disclosed in the detailed description include security techniques for a Peripheral Component Interconnect (PCI) express (PCIE) system. In an exemplary aspect, a transport layer protocol (TLP) packet has a TLP prefix prepended indicating the security features of the TLP packet. Such security features may include a counter or counter equivalent to prevent replay attacks, encryption of a payload of the TLP packet to prevent snooping, and/or an authentication value calculated from one or more portions of the TLP packet to detect tampering. The TLP prefix may indicate which, if any, of the security features are present in the associated TLP packet. In an exemplary aspect, the counter may be a monotonically-increasing number included in each packet. In an exemplary aspect, the authentication value may be an integrity check value (ICV) appended to the TLP packet. The ICV is based on the TLP packet and any TLP prefixes including a security prefix. At a receiver, if the ICV does not match, then the receiver has evidence that the TLP packet may have been subjected to tampering.

In this regard in one aspect, a method of providing secure communications between devices on either end of a PCIE link is disclosed. The method includes prepending a TLP prefix onto a TLP packet. The TLP prefix includes an indication that the TLP packet is a secure packet. The method also includes appending a cryptographically-generated identifier calculated at least in part on a portion of the TLP packet to the TLP packet. The method also includes sending the TLP packet from a first one of the devices over the PCIE link to the other one of the devices.

In another aspect, a method of providing secure communications between devices on either end of a PCIE link is disclosed. The method includes prepending a TLP prefix onto a TLP packet. The TLP prefix includes an indication that the TLP packet is a secure packet. The method also includes encrypting a payload of the TLP packet. The method also includes sending the TLP packet from a first one of the devices over the PCIE link to the other one of the devices.

In another aspect, a method of providing secure communications between devices on either end of a PCIE link is disclosed. The method includes prepending a TLP prefix onto a TLP packet. The TLP prefix includes an indication that the TLP packet is a secure packet and includes a counter value representing a monotonically-increasing counter to detect replay attacks. The method also includes sending the TLP packet from a first one of the devices over the PCIE link to the other one of the devices.

In another aspect, a PCIE system is disclosed. The PCIE system includes a host device. The host device includes a root complex, a host encryption/decryption engine, and a host interface. The PCIE system also includes a PCIE link coupled to the host interface. The PCIE system also includes an endpoint device. The endpoint device includes an endpoint interface coupled to the PCIE link and an endpoint encryption/decryption engine. The root complex is configured to prepend a TLP prefix onto a TLP packet. The TLP prefix includes an indication that the TLP packet is a secure packet and a counter value representing a monotonically-increasing counter to detect replay attacks. The root complex is also configured to encrypt a payload of the TLP packet. The root complex is also configured to append a cryptographically-generated identifier calculated at least in part on a portion of the TLP packet to the TLP packet. The root complex is also configured to send the TLP packet from a first one of the host device and the endpoint device over the PCIE link to the other one of the host device and the endpoint device.

### BRIEF DESCRIPTION OF THE FIGURES

FIG. 1 is a block diagram of an exemplary computing system with devices coupled by Peripheral Component Interconnect (PCI) express (PCIE) links;

FIG. 2 illustrates a block diagram of an exemplary PCIE endpoint device and, particularly, configuration registers within the endpoint;

FIG. 3 illustrates a block diagram of a host having a processor and PCIE hardware with registers according to an exemplary aspect of the present disclosure;

FIG. 4 is a simplified schematic diagram of an exemplary computing system within a vehicle;

FIG. 5 is a simplified PCIE write packet with a prefix and suffix according to exemplary aspects of the present disclosure;

FIG. 6 is a simplified PCIE read packet with a prefix and suffix according to exemplary aspects of the present disclosure;

FIG. 7 is a simplified PCIE completion packet with a prefix and suffix according to exemplary aspects of the present disclosure;

FIG. 8 provides a simplified diagram of packet flow through a PCIE system according to exemplary aspects of the present disclosure;

FIG. 9 is a block diagram of an exemplary mobile terminal that can include a PCIE system that uses security features according to the present disclosure; and

FIGS. 10A and 10B are flowcharts of exemplary security-driven processes according to the present disclosure from a root complex and endpoint perspective, respectively.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include security techniques for a Peripheral Component Interconnect (PCI) express (PCIE) system. In an exemplary aspect, a transport layer protocol (TLP) packet has a TLP prefix prepended indicating the security features of the TLP packet. Such security features may include a counter or counter equivalent to prevent replay attacks, encryption of a payload of the TLP packet to prevent snooping and/or an authentication value calculated from one or more portions of the TLP packet to detect tampering. The TLP prefix may indicate which, if any, of the security features are present in the associated TLP packet. In an exemplary aspect, the counter may be a monotonically-increasing number included in each packet. In an exemplary aspect, the authentication value may be an integrity check value (ICV) appended to the TLP packet. The ICV is based on the TLP packet and any TLP prefixes including a security prefix. At a receiver, if the ICV does not match, then the receiver has evidence that the TLP packet may have been subjected to tampering.

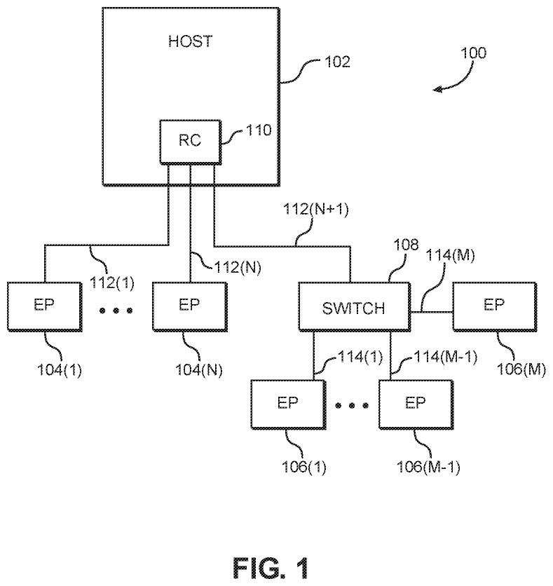

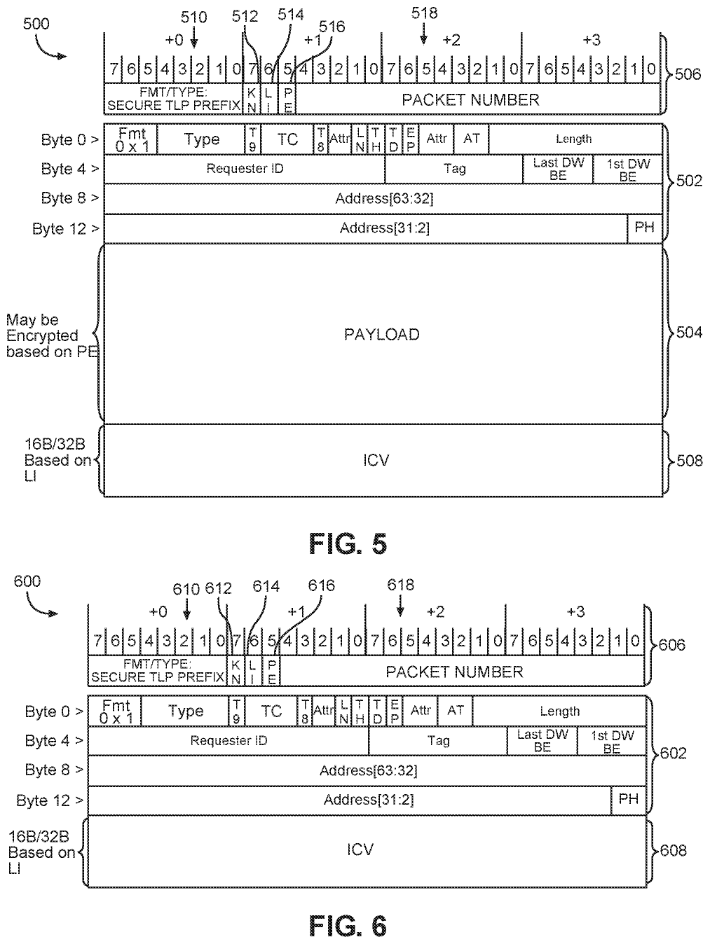

Before addressing particular aspects of the present disclosure, an overview of a PCIE system and exemplary use cases is provided with reference to FIGS. 1-4. Exemplary packets according to the present disclosure are provided beginning with reference to FIG. 5.

In this regard, FIG. 1 illustrates a computing environment 100 with a host 102 coupled to a plurality of devices 104(1)-104(N) directly and to a second plurality of devices 106(1)-106(M) through a switch 108. The host 102 may include a PCIE root complex (RC) 110 that includes a link interface (not illustrated directly) that is configured to couple to plural PCIE links 112(1)-112(N+1). Note that PCIE links may sometimes be referred to as a bus or buses. However, as the PCIE link is a point-to-point link, the term link is used in the PCIE specification. The switch 108 communicates to the devices 106(1)-106(M) through PCIE links 114(1)-114(M). The devices 104(1)-104(N) and 106(1)-106(M) may be or may include PCIE endpoints. In a first exemplary aspect, the computing environment 100 may be a single computing device such as a computer with the host 102 being a central processing unit (CPU) and the devices 104(1)-104(N) and 106(1)-106(M) being internal components such as hard drives, disk drives, or the like. In a second exemplary aspect, the computing environment 100 may be a computing device where the host 102 is an integrated circuit (IC) on a board and the devices 104(1)-104(N) and 106(1)-106(M) are other ICs within the computing device. In a third exemplary aspect, the computing environment 100 may be a computing device having an internal host 102 coupled to external devices 104(1)-104(N) and 106(1)-106(M) such as a server coupled to one or more external memory drives. Note that these aspects are not necessarily mutually exclusive in that different ones of the devices may be ICs, internal, or external relative to a single host 102.

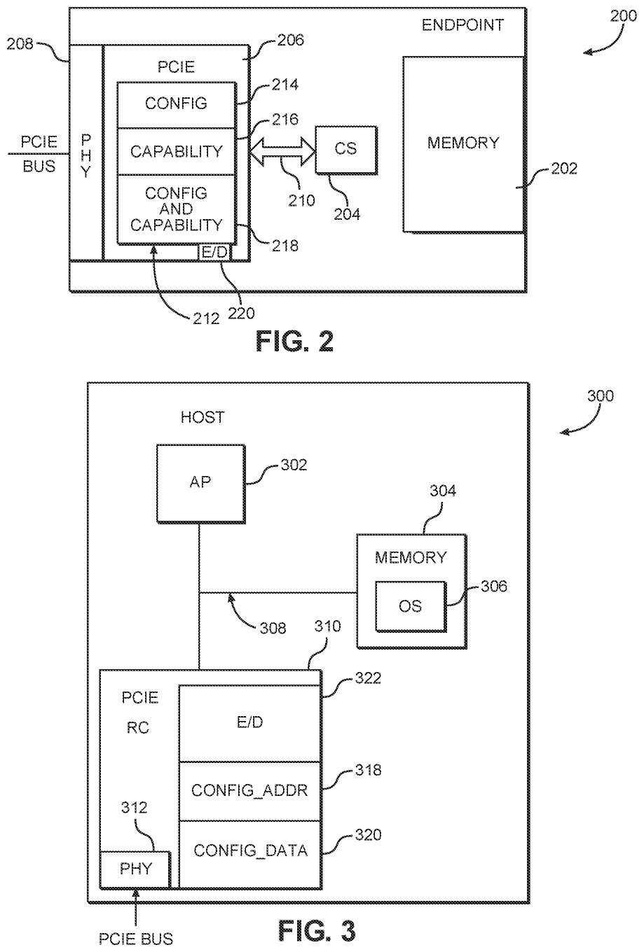

FIG. 2 provides a block diagram of a device 200 that may be one of the devices 104(1)-104(N) or the devices 106(1)-106(M) of FIG. 1. In particular, the device 200 acts as an endpoint in a PCIE system, and may be, for example, a memory device that includes a memory element 202 and a control system 204. Further, the device 200 includes a PCIE hardware element 206 that includes a link interface configured to couple to a PCIE link. The PCIE hardware element 206 may include a physical layer (PHY) 208 that is, or works with, the link interface to communicate over the PCIE link. The control system 204 communicates with the PCIE hardware element 206 through a system bus 210. The PCIE hardware element 206 may further include a plurality of registers 212. The registers 212 may be conceptually separated into configuration registers 214 and capability registers 216. The configuration registers 214 and the capability registers 216 are defined by the original PCI standard, and more recent devices that include the registers 214 and 216 are backward compatible with legacy devices. The ability to use the encryption systems or other security mechanisms of the present disclosure may be stored in the capability registers 216 or extended configuration register space 218 and accessed on start up or initialization. The PCIE hardware element 206 may further have an encryption/decryption engine 220 that encrypts and decrypts packets sent according to the present disclosure.

Similarly, FIG. 3 illustrates a host 300 which may be the host 102 of FIG. 1. The host 300 may include an application processor 302 or other processor core which communicates with a memory element 304 having an operating system 306 operating therewith. A system bus 308 interconnects the application processor 302 with the memory element 304 and a PCIE RC 310. The PCIE RC 310 may include a PHY 312 that works with or is a link interface configured to couple to a PCIE link. The PCIE RC 310 further includes a plurality of registers including a configuration address register 318 (CONFIG_ADDR) and a data register 320 (CONFIG_DATA). The capabilities and configurations of the various endpoints may be stored in the data register 320 so that the root complex may use the security features of the present disclosure with those endpoints which are so enabled. Further, the PCIE RC 310 may include an encryption/decryption engine 322 that encrypts and decrypts packets sent according to the present disclosure.

Note that having the encryption/decryption engines 220 and 322 at both the endpoint and the root complex allows bi-directional encrypted communication.

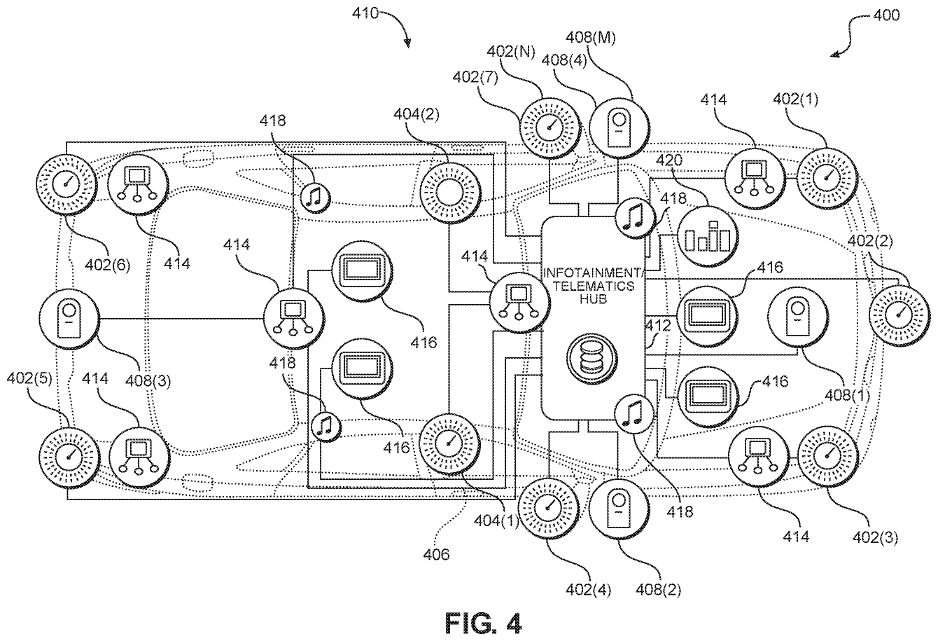

FIG. 4 is a simplified block diagram of a vehicle 400 which may include one or more PCIE links therein. The vehicle 400 is illustrated as an automobile, but could be another form of vehicle such as a motorcycle, a boat, a plane, or the like. The vehicle 400 may include a variety of sensors 402(1)-402(N), where, as illustrated, N=7. It should be appreciated that more or fewer than seven sensors 402 may be present. The sensors 402(1)-402(N) may be proximity sensors that use sonar, lasers, or some form of radar to detect proximate objects. Additionally, the vehicle 400 may include one or more internal sensors 404(1)-404(2). The internal sensors 404(1)-404(2) may detect whether a door 406 is open or other internal condition of the vehicle 400. The vehicle 400 may further include one or more cameras 408(1)-408(M), where, as illustrated, M=4. It should be appreciated that more or fewer than four cameras 408 may be present. The vehicle 400 may have a network 410 that couples some or all of the sensors 402 and 404 to a hub 412. Network bridges 414 may be present to assist in providing the network 410. Displays 416 and speakers 418 may also be associated with the network 410. The hub 412 may include a control system that accesses software stored in memory 420.

It should be appreciated that the illustration of the vehicle 400 in FIG. 4 is greatly simplified. The network 410 may be a single homogeneous network such as a common bus having a multi-drop or ring topology or may be formed from distinct communication links such as separate point-to-point cables. There may likewise be multiple hubs for multiple purposes. Some inputs may go to one or more hubs. The hubs may be interconnected and/or duplicated for redundancy purposes. In the event that the communication links are point-to-point cables, PCIE may be used, and thus, automotive or other vehicular environments may benefit from exemplary aspects of the present disclosure. In particular, automobile providers may not want their algorithms exposed to competitors or to be hacked in such a way that autonomous driving or engine performance is compromised.

Exemplary aspects of the present disclosure provide three supporting security measures to assist in providing secure messaging between hosts and endpoints over a PCIE link. A first security measure is encrypting a payload of a packet such that the packet cannot be snooped. A second security measure is using a counter or counter equivalent to prevent replay attacks. A third security measure is to provide a cryptographically-generated identifier or authentication mechanism calculated at least in part on the contents of a packet to detect tampering. To assist in using these security measures, exemplary aspects of the present disclosure provide a TLP prefix that includes an indication as to whether the specific security measures are used.

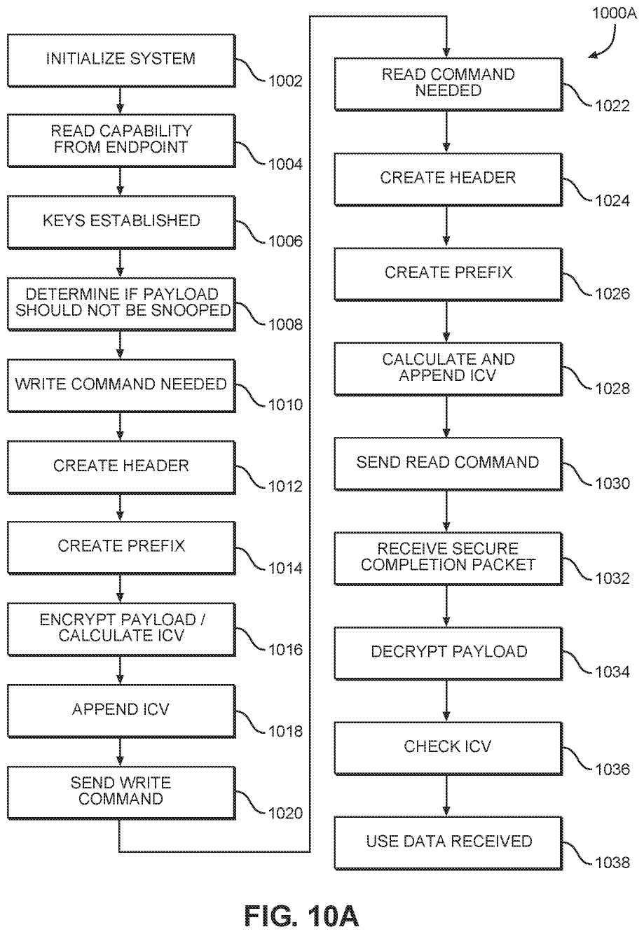

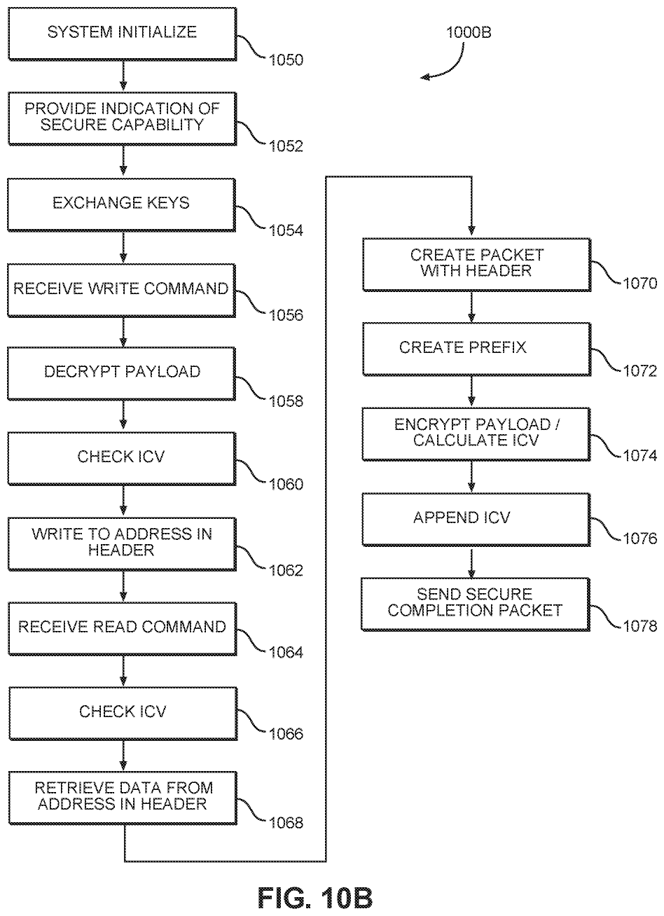

In this regard, processes 1000A and 1000B for implementing the security techniques of the present disclosure are provided with reference to FIGS. 10A and 10B, respectively. The process 1000A is from the root complex point-of-view, and the process 1000B is from the endpoint point-of-view. While the processes 1000A and 1000B assume certain points of view for the sake of illustration, it should be appreciated that communication may be bi-directional, and the endpoint 200 can read from and write to the root complex 310 within a host 300. In this regard, the process 1000A begins with the initialization of the system (block 1002). This initialization may occur at start up, reboot, or the like, but involves the root complex 310 recognizing that the endpoint 200 has been connected to the PCIE link. The root complex 310 reads the capabilities of the endpoint 200 (block 1004) such as by reading the registers in the capability registers 216. Once the root complex 310 knows that the endpoint 200 is capable of secure PCIE, the root complex 310 may enable the secure function in the endpoint 200 and establish and exchange secure keys (block 1006). Keys may be negotiated based on a public key infrastructure (PKI) system through a Diffie-Helman key exchange or any other key exchange protocol. Keys may be provisioned and used as-is or with some derivation if needed or desired.

The process 1000A continues with the root complex 310 determining if the payload should not be snooped (block 1008). This determination may be based on a default rule, a type of endpoint to which the root complex 310 is communicating, or other rule as needed or desired. At some point the root complex 310 is informed that the host 300 has data that is to be written to the endpoint. Thus, a write command is needed (block 1010) to provide the data to the endpoint 200. The root complex 310 creates a header (block 1012) corresponding to the write command with the appropriate address. The header may include a packet number that acts as a counter to prevent replay attacks. A TLP prefix is created containing an indication of which, if any, security features are being used (block 1014). The payload is encrypted and an integrity check value (ICV) is calculated (block 1016) depending on whether encryption was indicated at block 1008 and/or whether tamper detection is desired. This step may be skipped if there is no requirement to protect the payload from snooping or tamper detection. The root complex 310 appends the ICV (block 1018) based on the prefix, the header, and the payload. The write command is sent to the endpoint 200 (block 1020) over the PCIE link.

In the event the root complex 310 is instructed to acquire data from the endpoint 200, a read command is needed (block 1022), and the process 1000A continues. The root complex 310 creates a header (block 1024) with an address from which data is to be read. The root complex 310 creates a TLP prefix (block 1026) indicating the secure nature of the packet. The root complex 310 calculates and appends an ICV (block 1028) based on the combined header and prefix. The root complex 310 then sends the read command (block 1030). As a read command, there is no payload typically, and thus, encryption may be omitted. The root complex 310 should eventually receive a secure completion packet from the endpoint 200 (block 1032). The root complex 310 decrypts the payload of the secure completion packet if encryption was indicated (block 1034) and checks the ICV of the secure completion packet (block 1036) to see if the data in the payload of the secure completion packet has been compromised. Note that the decryption of the payload of the packet and the check of the ICV may occur at the same time or in reversed order without departing from the scope of the present disclosure. If the ICV check fails, the receiver may invoke a failure comparable to a failure for an end-to-end cyclic redundancy check (ECRC) error. That is, for a memory read command, a completion is returned with an Unsupported Request (UR) Completion Status. As the receiver cannot differentiate between a naturally occurring error and an attack, software may be used to make such determination. Alternatively, the receiver may terminate the connection as corrupted. After termination, a new encryption link may be established with new keys. Likewise, an alert may be provided to an intrusion detection system or the like. Other shifts in encryption (algorithm, length of key, or the like) may also be performed to facilitate re-establishment of a secure or safe state. The packet number of the TLP prefix may also be verified to stop replay attacks. The root complex 310 may then use the data received (block 1038).

Note that the read and write commands may be reversed, duplicated, or otherwise occur in a different order than that presented in process 1000A. Note further that the ICV may be replaced with some other authentication value or cryptographically-generated identifier that is calculated based at least in part on one or more portions of the packet. Likewise, while a packet number that acts as a monotonically-increasing counter is contemplated as being used to detect replay attacks, other forms of counter equivalents may be used without departing from the scope of the present disclosure.

The process 1000B from the endpoint 200 side is similar in that the process 1000B starts at system initialization (block 1050). During initialization, the endpoint 200 may provide an indication that the endpoint 200 has secure capability (block 1052). If the root complex 310 enables secure communication, the root complex 310 and the endpoint 200 exchange keys (block 1054). At some point, the root complex 310 sends, and the endpoint 200 receives, a write command (block 1056). The endpoint 200 decrypts the payload (block 1058) if the payload is encrypted and checks the ICV of the command (block 1060). The ICV may be checked before the payload is decrypted if desired. The endpoint 200 also checks the packet number to see if this packet is the next in sequence to prevent replay attacks (or at least detect an attempted replay attack). Out of order packets may be discarded. If the ICV is correct, then the endpoint 200 writes the data from the payload to the address in the header (block 1062). Such address may correspond to an address in the memory element 202.

At some other time, a read command is received (block 1064). The endpoint 200 checks the ICV (block 1066). If the ICV is correct, then the endpoint 200 retrieves the data from the address (in the memory element 202) indicated in the header (block 1068) and creates a packet with a header (block 1070). The packet may include an appropriate packet number. The endpoint 200 may then create a TLP prefix (block 1072). The endpoint 200 encrypts the payload if encryption is indicated and calculates an ICV for the packet (block 1074) and appends the ICV (block 1076) to the packet. The endpoint 200 then sends a secure completion packet with the payload to the root complex 310 (block 1078).

Again, it should be noted that the nature of bi-directional communication could invert the roles of the root complex 310 and the endpoint 200 with respect to the origin of a read/write command and the corresponding response.

Further, it should be noted that in instances where there is an intervening switch or bridge (e.g., the switch 108), aspects of the present disclosure are secure end-to-end such that such an intermediate switch does not impact the encryption. For example, the switch 108 may pass the packet through without checking or changing the data. All that the switch 108 has to evaluate is the header for the address so that the pass through may occur, and the header is not encrypted. It should be appreciated that if there is no intervening switch, then exemplary aspects of the present disclosure are effectively link-based security (e.g., the link between host 102 to EP 104(1) is both end-to-end secure as well as link-based secure). Note that each link of a multi-step PCIE system (e.g., from host 102 to EP 106(1) through the switch 108) may be link-based secure, although in such case, each component may need to be authenticated. This structure requires the switches 108 to be encryption capable. Legacy switches that do not have encryption capability may need to be replaced in such a system.

To implement the processes 1000A and 1000B, a new TLP prefix is defined and prepended to a packet. Likewise, an ICV or other authentication value calculated based at least in part on portions of the packet is appended to the packet. Exemplary modified packets are illustrated in FIGS. 5-7. In this regard, FIG. 5 illustrates a secure write packet 500 that has a header 502, a payload 504 to be written to the endpoint 200 (or if originating at the endpoint 200, to be written to the host 300), a TLP prefix 506, and an ICV 508. The TLP prefix 506 is prepended to the header 502, and the ICV 508 is appended after the payload 504. The header 502 is never encrypted as the information in the header 502 is required for routing purposes. The header 502 is well understood with fields defined by the PCIE specification.

It should be appreciated that the header 502 may be signed (but still not encrypted) as outlined in AES-GCM-128. Such signed headers may be referred to as “additional authenticated data” (AAD).

The TLP prefix 506 includes a TLP identifier field 510 which indicates that the TLP prefix 506 is a security prefix. Further, the TLP prefix 506 includes a key number (KN) bit 512, a long ICV (LI) bit 514, a payload encrypted (PE) bit 516 (or alternatively referred to as a TLP encrypted (TE) bit), and a packet number field 518. It should be appreciated that TLP prefixes are defined in terms of eight-bit sections. The TLP identifier field 510 is eight bits, and the KN bit 512, the LI bit 514, and the PE bit 516 are another three bits. The packet number field 518 may be twenty-one (21) bits to provide an appropriately-sized TLP prefix 506.

The payload 504 may be encrypted if needed or desired. If the payload 504 is encrypted, this state is indicted by setting the PE bit 516. If the data in the payload 504 merely needs to avoid tampering, and there is no concern about snooping, then the data in the payload 504 may not be encrypted. Forgoing encryption in this fashion may reduce the overall overhead that would otherwise be incurred encrypting at the root complex 310 and decrypting at the endpoint 200. Note that in an exemplary aspect, if the PE bit 516 is set in a read request, the return completion payload should be encrypted. Note that TLP data is DWORD aligned (e.g., 4 bytes). A block cypher may accept 16 bytes of data (e.g., block aligned). Thus, padding data may not be sent but may be appended by a security layer at the receiver to perform calculations.

The ICV 508 may be a long ICV having thirty-two (32) bytes or a short ICV having sixteen (16) bytes. The difference in length of the ICV 508 is denoted in the LI bit 514. As noted above, the ICV 508 may be calculated using an integrity cypher algorithm such as AES-GCM-128 and may be calculated across the secure TLP prefix, the TLP header, and the payload (i.e., it is calculated at least in part based on one or more portions of the packet).

Note that while specific fields and bits are contemplated, these bits and fields may be modified without departing from the scope of the present disclosure. For example, the LI bit 514 may be omitted if only one size ICV is permitted. Likewise, the LI bit 514 may more generically indicate the presence or absence of an authentication value (or a cryptographically-generated identifier) appended after the packet. While exemplary aspects of the present disclosure contemplate that the ICV may replace a cyclic redundancy check (CRC) field (e.g., the CRC field defined by the PCIE specification) in a packet, it may be possible to append an ICV or other authentication value after the CRC field. It should be appreciated that in addition to detecting tampering, use of the ICV or other cryptographically-generated identifier may also detect bit errors such as is currently done with the CRC.

The KN bit 512 designates which key is being used. As is understood in the cryptography field, keys can expire after a certain amount of time. Rekeying is an understood process. However, because the present disclosure relies on a shared key, the endpoint may also be rekeyed when the first key expires. So that the endpoint knows which key is being used (e.g., before or after rekeying), the KN bit 512 may be toggled to indicate which key is being used.

The packet number field 518 contains a packet number which is a monotonically-increasing number that is used to prevent replay attacks. The packet number may also be used to help detect missing packets if needed or desired. In use, the receiver expects valid packets with an incrementing packet number. If a packet is received with a non-sequential packet number, the packet may be discarded, even if the ICV is valid. By discarding packets with duplicative or non-sequential packet numbers, replay attacks (reusing the same packet to achieve duplicative results) are avoided. If twenty-one bits does not fit for some reason, the packet number may be shortened or just the least significant bits sent.

Likewise, instead of counting packets with the packet number field 518, the packet number field 518 may refer to a TLP number or some other element may be counted (e.g., sets of four packets or sets of three write commands) so long as it is monotonically increasing and able to be compared with a readily verifiable metric to defeat replay attacks. It should be appreciated that the packet number may also be used to formulate an initialization vector (IV) as an input into a block cypher algorithm such as AES-GCM-128.

In an exemplary aspect, the packet number represents the twenty-one least significant bits of a larger counter (e.g., 50 bits) to represent how long a key may last before being refreshed. When the larger counter is about to overflow, the KN bit 512 may be toggled to indicate the second bit is to be used. The larger the counter, the less frequently the key would have to be refreshed.

To prevent replay, the larger counter is incremented on both the root complex and the endpoint. It should be appreciated that if the counter is reset during a power cycle event, a replay attack may be enabled. Thus, in an exemplary aspect, the counter is maintained across power cycles. To this end, one side may store the last counter value in a secure non-volatile memory. Note that devices which exchange keys during a session start up can restart the counter. A configuration register may also be used to set the counter. As a further option, each type of PCIE TLP (posted, non-posted, completion) may have a separate counter.

Similarly, FIG. 6 illustrates a secure read packet 600 that has a header 602, a TLP prefix 606, and an ICV 608. The TLP prefix 606 is prepended to the header 602, and the ICV 608 is appended after the header 602. As this is a read command, there is no payload. The header 602 is never encrypted as the information in the header 602 is required for routing purposes. The header 602 is well understood with fields defined by the PCIE specification.

It should be appreciated that the header 602 may be signed (but still not encrypted) as outlined in AES-GCM-128. Such signed headers may be referred to as “additional authenticated data” (AAD).

The TLP prefix 606 includes a TLP identifier field 610 which indicates that the TLP prefix 606 is a security prefix. Further, the TLP prefix 606 includes a KN bit 612, a LI bit 614, a PE bit 616, and a packet number field 618. It should be appreciated that TLP prefixes are defined in terms of eight-bit sections. The TLP identifier field 610 is eight bits, and the KN bit 612, the LI bit 614, and the PE bit 616 are another three bits. The packet number field 618 may be twenty-one (21) bits to provide an appropriately-sized TLP prefix 606. The sub-portions of the TLP prefix 606 function as described above. The PE bit 616 indicates whether the returned payload should be encrypted.

It should be appreciated that as with the TLP prefix 506 of FIG. 5, the bits and fields of the TLP prefix 606 may be varied, renamed, or alternatively implemented without departing from the present disclosure.

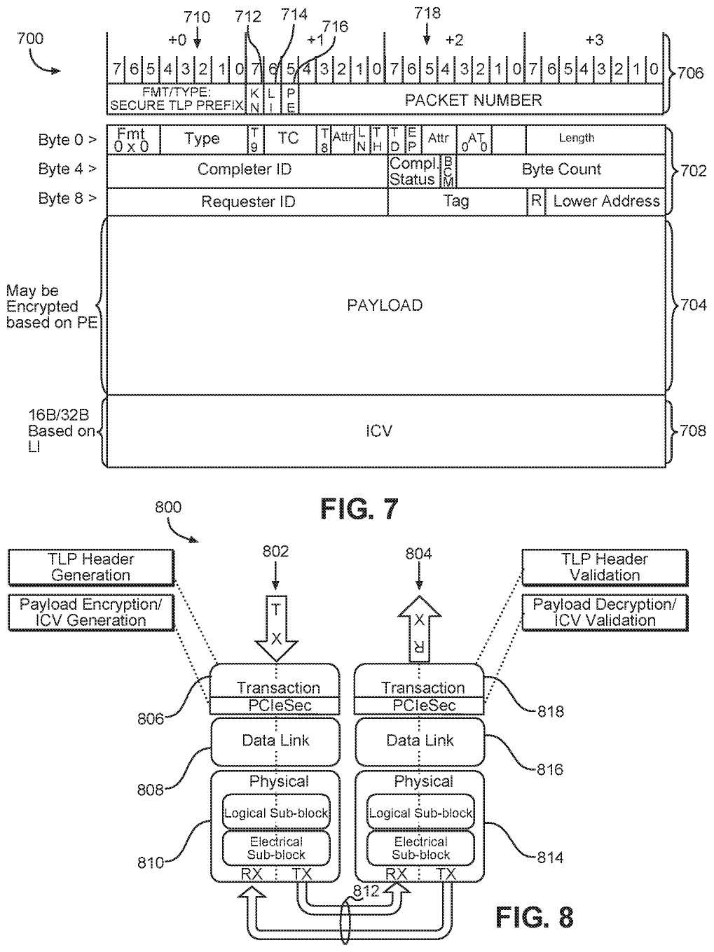

Similarly, FIG. 7 illustrates a secure completion packet 700 responsive to a read command. The secure completion packet 700 has a header 702, a payload 704 to be written to the endpoint, a TLP prefix 706, and an ICV 708. The TLP prefix 706 is prepended to the header 702, and the ICV 708 is appended after the payload 704. The header 702 is never encrypted as the information in the header 702 is required for routing purposes. The header 702 is well understood with fields defined by the PCIE specification.

It should be appreciated that the header 702 may be signed (but still not encrypted) as outlined in AES-GCM-128. Such signed headers may be referred to as “additional authenticated data” (AAD).

The TLP prefix 706 includes a TLP identifier field 710 which indicates that the TLP prefix 706 is a security prefix. Further, the TLP prefix 706 includes a KN bit 712, a LI bit 714, a PE bit 716, and a packet number field 718. It should be appreciated that TLP prefixes are defined in terms of eight-bit sections. The TLP identifier field 710 is eight bits, and the KN bit 712, the LI bit 714, and the PE bit 716 are another three bits. The packet number field 718 may be twenty-one (21) bits to provide an appropriately-sized TLP prefix 706.

It should be appreciated that as with the TLP prefix 506 of FIG. 5, the bits and fields of the TLP prefix 706 may be varied, renamed, or alternatively implemented without departing from the present disclosure.

FIG. 8 illustrates where in the stack aspects of secure signaling take place. In this regard FIG. 8 illustrates a system 800 having a transmitter 802 and a receiver 804. In the transmitter 802, at a transaction layer 806, the TLP header (e.g., 502, 602, 702) is generated along with the TLP prefix (e.g., 506, 606, 706) and the payload is optionally encrypted. Based on this, an ICV (e.g., 508, 608, 708) is calculated and appended. The combined packet is then passed to a data link layer 808 and to a physical layer 810, where the packet is sent over a PCIE link 812 to the receiver 804. At the receiver 804, the packet passes through a physical layer 814 and a data link layer 816 before reaching a transaction layer 818 where the payload is decrypted (including any padding), the ICV is validated, and the TLP header is evaluated to output the payload to an appropriate address. As noted above, in an end-to-end secure system, the intermediate switches 108 do not alter the TLP packets and are not required to decrypt or validate the data. A PCIE port may send secure or unsecure TLP packets based on whether a secure TLP prefix is prepended. It should be appreciated that a completion for a secure read request TLP must be returned with a secure TLP prefix.

It should be appreciated that an RC 110 which is generating secure requests should know which key and counter set it should use to protect the data. If there is only one endpoint 200 that is secure, then such determination is relatively simple. However, if plural endpoints (e.g., 104(1)-104(N)) are using secure messaging, the determination is non-trivial. As described, a key and counter are an end-to-end attribute and would differ from PCIE link to PCIE link for a single RC 110. Thus, the RC 110 needs to be able to discern the destination endpoint. One solution would be to use software that would sniff data within the RC 110 to determine a destination and alert the PHY as to the destination. A second solution would be to define PCIE capabilities in which a PCIE driver would build a table of address ranges and the corresponding security attributes.

### Secure Memory Map:

| Base | Limit | Secure | Encrypted | Key Table Index |
|---|---|---|---|---|
| 5000 | 10000 | Y | Y | 1 |
| 15000 | 1000 | N | N | — |
| 20000 | 10000 | Y | Y | 1 |
| 30000 | 5000 | Y | N | 2 |
| 40000 | 1000 | Y | Y | 3 |
| 45000 | 1000 | Y | Y | 1 |

Note that the dashed line in the second row may indicate an unsecure endpoint, or if the address is not within the table, the unsecure nature may be inferred.

Note that an endpoint may have multiple entries corresponding to different memory regions of the same endpoint (e.g., for different functions) but would still use the same key as the endpoint is the same.

Some additional precautions may be present when a switch, such as switch 108 of FIG. 1 is present. Such a switch should be trusted and authenticated. Likewise, the switch 108 should block traffic received on a secure link from being sent on an unsecure link. A key management entity should maintain secure key-pairs through the whole PCIE topology. A secure PCIE link may be brought up sequentially starting with the link closest to the RC 110 and moving outward to assist in making sure the end-to-end link is secure (e.g., link 112(N+1) first, then link 114(1) of FIG. 1). Note that there may be additional vulnerabilities for a switch 108 that are caused by internal vulnerabilities. For example, a packet going from endpoint 106(1) to endpoint 106(M) may pass through an internal conductor within the switch 108. If the data is encrypted end-to-end, then the data remains secure on the internal conductor. However, if the security is link based, then the data may have been unencrypted at arrival at the switch 108, and then re-encrypted as it leaves the switch 108, leaving the data unprotected on the internal conductors. Alternatively, additional security measures may be provided to protect the data in such situations.

The security techniques for a PCIE system according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, automobile, vehicle and a multicopter.

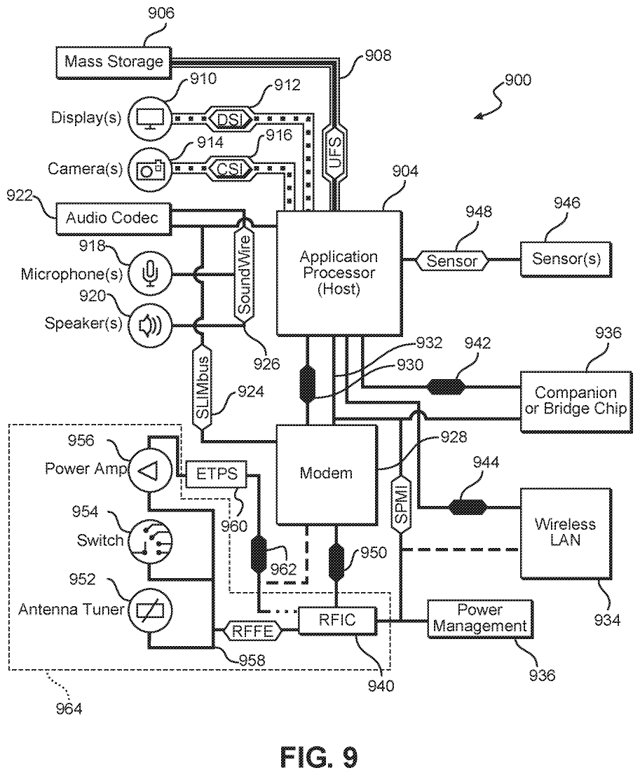

In this regard, FIG. 9 is a system-level block diagram of an exemplary mobile terminal 900 such as a smart phone, mobile computing device tablet, or the like. The mobile terminal 900 includes an application processor 904 (sometimes referred to as a host) that communicates with a mass storage element 906 through a universal flash storage (UFS) bus 908. The application processor 904 may further be connected to a display 910 through a display serial interface (DSI) bus 912 and a camera 914 through a camera serial interface (CSI) bus 916. Various audio elements such as a microphone 918, a speaker 920, and an audio codec 922 may be coupled to the application processor 904 through a serial low-power interchip multimedia bus (SLIMbus) 924. Additionally, the audio elements may communicate with each other through a SOUNDWIRE bus 926. A modem 928 may also be coupled to the SLIMbus 924 and/or the SOUNDWIRE bus 926. The modem 928 may further be connected to the application processor 904 through a PCIe bus 930 and/or a system power management interface (SPMI) bus 932. PCIE buses such as the PCIE bus 930 may benefit from exemplary aspects of the present disclosure.

With continued reference to FIG. 9, the SPMI bus 932 may also be coupled to a wireless local area network (LAN or WLAN) IC (LAN IC or WLAN IC) 934, a power management integrated circuit (PMIC) 936, a companion IC (sometimes referred to as a bridge chip) 938, and a radio frequency IC (RFIC) 940. It should be appreciated that separate PCI buses 942 and 944 may also couple the application processor 904 to the companion IC 938 and the WLAN IC 934. The application processor 904 may further be connected to sensors 946 through a sensor bus 948. The modem 928 and the RFIC 940 may communicate using a bus 950.

With continued reference to FIG. 9, the RFIC 940 may couple to one or more RFFE elements, such as an antenna tuner 952, a switch 954, and a power amplifier 956 through a radio frequency front end (RFFE) bus 958. Additionally, the RFIC 940 may couple to an envelope tracking power supply (ETPS) 960 through a bus 962, and the ETPS 960 may communicate with the power amplifier 956. Collectively, the RFFE elements, including the RFIC 940, may be considered an RFFE system 964. It should be appreciated that the RFFE bus 958 may be formed from a clock line and a data line (not illustrated).

It should be appreciated that designers may have different priorities with respect to security. There are trade-offs for using link-based security versus end-to-end security. These differences are noted in the second appendix attached hereto.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A method of providing secure communications between devices on either end of a Peripheral Component Interconnect (PCI) express (PCIE) link, comprising:
prepending a transport layer protocol (TLP) prefix onto a TLP packet, wherein the TLP prefix comprises an indication that the TLP packet is a secure packet;
appending a cryptographically-generated identifier calculated at least in part on a portion of the TLP packet to the TLP packet; and
sending the TLP packet from a first one of the devices over the PCIE link to the other one of the devices.

2. The method of claim 1, further comprising forming the TLP packet.

3. The method of claim 2, wherein forming the TLP packet comprises making a write command in the TLP packet.

4. The method of claim 3, further comprising encrypting a payload in the TLP packet.

5. The method of claim 2, wherein forming the TLP packet comprises making a read command in the TLP packet.

6. The method of claim 5, further comprising, responsive to sending the TLP packet, receiving a secure completion packet.

7. The method of claim 6, further comprising decrypting a payload in the secure completion packet.

8. The method of claim 1, wherein prepending the TLP prefix onto the TLP packet comprises prepending with a TLP prefix comprising a payload encrypted bit.

9. The method of claim 1, wherein appending the cryptographically-generated identifier to the TLP packet comprises appending an integrity check value (ICV) to the TLP packet.

10. The method of claim 1, wherein prepending the TLP prefix onto the TLP packet comprises prepending with a TLP prefix comprising a packet number.

11. The method of claim 1, wherein prepending the TLP prefix onto the TLP packet comprises prepending with a TLP prefix comprising a key number bit.

12. A method of providing secure communications between devices on either end of a Peripheral Component Interconnect (PCI) express (PCIE) link, comprising:
prepending a transport layer protocol (TLP) prefix onto a TLP packet, wherein the TLP prefix comprises an indication that the TLP packet is a secure packet;
encrypting a payload of the TLP packet; and
sending the TLP packet from a first one of the devices over the PCIE link to the other one of the devices.

13. The method of claim 12, further comprising forming the TLP packet.

14. The method of claim 13, wherein forming the TLP packet comprises making a write command in the TLP packet.

15. The method of claim 13, wherein prepending the TLP prefix onto the TLP packet comprises prepending with a TLP prefix comprising a payload encrypted bit.

16. The method of claim 12, wherein prepending the TLP prefix onto the TLP packet comprises prepending with a TLP prefix comprising a packet number.

17. A method of providing secure communications between devices on either end of a Peripheral Component Interconnect (PCI) express (PCIE) link, comprising:
prepending a transport layer protocol (TLP) prefix onto a TLP packet, wherein the TLP prefix comprises an indication that the TLP packet is a secure packet and includes a counter value representing a monotonically-increasing counter to detect replay attacks; and
sending the TLP packet from a first one of the devices over the PCIE link to the other one of the devices.

18. The method of claim 17, further comprising forming the TLP packet.

19. The method of claim 18, wherein forming the TLP packet comprises making a write command in the TLP packet.

20. The method of claim 19, further comprising encrypting a payload in the TLP packet.

21. The method of claim 18, wherein forming the TLP packet comprises making a read command in the TLP packet.

22. The method of claim 17, wherein prepending the TLP prefix onto the TLP packet comprises prepending with a TLP prefix comprising a payload encrypted bit.

23. The method of claim 17, further comprising appending a cryptographically-generated identifier to the TLP packet.

24. The method of claim 17, further comprising running different counters for different types of packets.

25. The method of claim 17, further comprising separate counters for read commands, write commands, and completion packets.

26. A Peripheral Component Interconnect (PCI) express (PCIE) system comprising:
a host device comprising:
a root complex;
a host encryption/decryption engine; and
a host interface;
a PCIE link coupled to the host interface; and
an endpoint device comprising:
an endpoint interface coupled to the PCIE link; and
an endpoint encryption/decryption engine;
wherein the root complex is configured to:
prepend a transport layer protocol (TLP) prefix onto a TLP packet,
wherein the TLP prefix comprises:
an indication that the TLP packet is a secure packet; and
a counter value representing a monotonically-increasing counter to detect replay attacks;
encrypt a payload of the TLP packet;
append a cryptographically-generated identifier calculated at least in part on a portion of the TLP packet to the TLP packet; and
send the TLP packet from a first one of the host device and the endpoint device over the PCIE link to the other one of the host device and the endpoint device.

27. The PCIE system of claim 26, further comprising a switch positioned within the PCIE link.

28. The PCIE system of claim 27, wherein the host device is configured to provide end-to-end security and the switch is configured to pass the TLP packet through without modification.

29. The PCIE system of claim 27, wherein the switch is configured to decrypt the TLP packet and re-encrypt prior to sending the TLP packet to the endpoint device.

30. The PCIE system of claim 26, wherein the PCIE system is integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
